(19) United States
(12) Patent Application Publication
(10) Pub. No.: US 2025/0375800 A1
(43) Pub. Date: Dec. 11, 2025

(54) AIR DELIVERY MANIFOLD WITH INTEGRATED, ADJUSTABLE FLOW DAMPER OUTLETS

(71) Applicant: ILLINOIS TOOL WORKS INC., GLENVIEW, IL (US)

(72) Inventors: Richard D. Rodrigo, Chalfont, PA (US); John Gorczyca, Lansdale, PA (US)

(21) Appl. No.: 19/215,527

(22) Filed: May 22, 2025

Related U.S. Application Data
(60) Provisional application No. 63/657,267, filed on Jun. 7, 2024.

(51) Int. Cl. B08B 5/04

(52) U.S. Cl. CPC B08B 5/046

(57) ABSTRACT

A vacuum system is provided for cleaning an object. The system includes an air manifold with a damper coupling attached a given end. The damper coupling is arranged within one of a plurality of outlets, the damper coupling receives a damper. Thus, a position and/or orientation of the damper may be adjusted by the damper coupling within the various outlets. In operation, the air manifold is configured to draw air from an intake flange, removing dust and air from the object being cleaned, which is exhausted to a vacuum system via the one or more outlets and dampers.

### CROSS REFERENCE TO RELATED APPLICATIONS

This application is a Non-Provisional patent application claiming priority to U.S. Provisional Patent Application No. 63/657,267 entitled “Air Delivery Manifold With Integrated, Adjustable Flow Damper Outlets” filed Jun. 7, 2024, which is herein incorporated by reference in its entirety.

### BACKGROUND

A variety of systems are configured to clean sheets or continuous materials, as conveyed via roller. For example, a vacuum device can remove dust from the material as it passes through the system. In some systems, the vacuum includes a plenum or manifold with an air intake to receive the dust, the manifold having a fixed outlet and/or hose to exhaust air carrying the dust. As may be appreciated, systems with enhanced flexibility provide additional value for customers. Thus, systems and device to clean web and sheet material with added product flexibility is desirable.

Further limitations and disadvantages of conventional and traditional approaches will become apparent to one of skill in the art, through comparison of such systems with the present disclosure as set forth in the remainder of the present application with reference to the drawings.

### BRIEF SUMMARY

The present disclosure relates generally to web and sheet cleaning systems and, more particularly, to web and sheet cleaning systems with configurable damper outlets integrated with an air manifold.

These and various other advantages, aspects and novel features of the present disclosure, as well as details of an illustrated embodiment thereof, will be more fully understood from the following description and drawings.

### BRIEF DESCRIPTION OF THE DRAWINGS

Certain aspects of embodiments disclosed herein by way of example are summarized below. It should be understood that these aspects are presented merely to provide the reader with a brief summary of certain forms an invention disclosed and/or claimed herein might take, and that these aspects are not intended to limit the scope of any invention disclosed and/or claimed herein. Indeed, any invention disclosed and/or claimed herein may encompass a variety of aspects that may not be set forth below.

FIG. 1 is a perspective view of an example vacuum system for cleaning an object, in accordance with aspects of this disclosure.

FIG. 2 is another perspective view of the example vacuum system presenting a damper, in accordance with aspects of this disclosure.

FIG. 3 is an exploded view of the example vacuum system, in accordance with aspects of this disclosure.

FIGS. 4A to 4C illustrate views of example vacuum system arrangements, in accordance with aspects of this disclosure.

FIGS. 5A and 5B illustrate perspective views of the example vacuum system arrangements of FIGS. 4B and 4C, in accordance with aspects of this disclosure.

The figures are not necessarily to scale. Where appropriate, similar or identical reference numbers are used to refer to similar or identical components.

### DETAILED DESCRIPTION

The present disclosure relates generally to web and sheet cleaning systems and, more particularly, to web and sheet cleaning systems with configurable damper outlets integrated with an air manifold.

A vacuum system is provided for cleaning an object (e.g., web and sheet cleaning). The system includes an air manifold with a damper coupling attached a given end. The damper coupling can be received at a plurality of outlets of the vacuum system to receive one or more of the damper couplings. Thus, a position and/or orientation of the dampers may be adjusted by coupling a damper to the various outlets via the damper couplings. In operation, the air manifold is configured to draw air from an intake flange, removing dust and air from the object being cleaned, which is exhausted to a vacuum collector system via the one or more outlets and dampers.

Operation of conventional vacuum cleaning systems for web and sheet materials (e.g., paper, film, foil materials, etc.) create particles that can contaminate the web. Contact and separation of the material with rollers of the machinery tends to generate static electricity, resulting in electrostatic adhesion of the contaminants (e.g., dust, lint, etc.), thereby bonding the contaminants to a surface of the material. Furthermore, the faster the machine moves the material, the more complicated this problem becomes. For example, contaminated surfaces tend to cause defects, which results in quality problems and costly additional work.

Such vacuum systems typically employ an air manifold or plenum with a single outlet in a fixed orientation. Thus, only a single installation configuration is available, limiting the arrangement and/or orientation of such vacuum systems in a working environment. From a design perspective, each fixed outlet/damper orientation represents a unique design and/or customization. Each unique design would require additional and/or specialized documentation, part number support, and/or installation expertise, as a list of non-limiting examples. Such designs also create a greater risk of error in installation and within a manufacturing environment.

By including a damper coupling, installation of the vacuum system can be configured in a variety of ways. This includes selecting a direction in which a damper vents, thus selection of where a hose to a vacuum source is connected to the vacuum system, and how it is oriented. Additionally, each damper is adjustable, thereby allowing an installer to optimize the airflow through the damper and thereby the cleaning power at the material.

Advantageously, incorporating a damper coupling into one or more of the multiple outlets of a vacuum system allows for more strategic placement of air hoses, which draw air from the manifold to a vacuum source. This opens the opportunity to modify and combine two or more such vacuum systems, thus providing tool to better control and/or enhance air flow at the air intake, as well as modify (e.g., increase) the size of a material that can be cleaned by a single vacuum system.

As utilized herein the terms “circuits” and “circuitry” refer to physical electronic components (i.e. hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

In disclosed examples, a vacuum system for cleaning an object includes an air manifold having a first end and a second end; one or more damper couplings arranged within one or more outlets to evacuate surface contamination, the one or more damper couplings being arranged on the first end of the air manifold; and one or more dampers coupled to the one or more outlets, wherein the one or more dampers are movable relative to the damper coupling to adjust a size of an opening of the one or more dampers.

In some examples, the two or more outlets arranged at first and second positions of a frame. In examples, the system further includes a damper collar, wherein each of the two or more outlets are configured to receive a damper of the one or more dampers via a damper collar. In examples, each of the two or more outlets are configured to receive a blank cover to substantially block evacuation of surface contamination from an outlet of the two or more outlets fitted with the blank cover.

In some examples, the damper coupling is removably mountable on the first end or the second end of the air manifold.

In some examples, the one or more dampers further comprises an adjustable plate configured to change position within the one or more dampers. In examples, the one or more dampers includes an adjustable lever connected to the adjustable plate, the adjustable lever configured to adjust an opening of the one or more dampers by changing a position or orientation of the adjustable plate. In examples, the adjustable fastener is manually adjustable.

In some examples, the second end of the air manifold is sealed.

In some examples, one of the air manifold, the damper coupling, or the damper is formed of a metallic material.

In some examples, the air manifold is a first air manifold, the system further comprising a second air manifold with a first end and a second end, the first end of the first air manifold being coupled to the first end of the second air manifold. In examples, the second air manifold includes a second frame to received one or more damper couplings, the second frame arranged at the second end of the second air manifold opposite the first air manifold.

In some examples, the system further incudes a third air manifold arranged between the first and the second air manifolds, the third air manifold including a third frame to receive one or more damper couplings, the third frame arranged at an end of the third air manifold between the first or the second air manifold.

In some disclosed examples, a vacuum system for removing surface contamination from an object includes an air manifold having a first end and a second end; one or more damper couplings arranged within one or more outlets to connect to a vacuum collector, the one or more damper couplings being arranged on the first end of the air manifold; one or more damper collars coupled to the one or more outlets of the damper collar, wherein the one or more dampers are movable relative to the damper collar to adjust a size of an opening of one or more dampers of the one or more damper collars; and one or more sensors configured to measure airflow or vacuum level through one or more openings of the one or more dampers.

In some examples, the one or more dampers includes an adjustable fastener configured to adjust an opening of the one or more damper collars relative to a surface of the frame. In examples, the system further includes a processor to receive data from the one or more sensors corresponding to the measured airflow or vacuum level.

In some examples, the system further includes an actuator configured to adjust an amount of the one or more openings of the one or more dampers, wherein the processor is configured to: determine whether the measured airflow or vacuum level is within a desirable range of airflow or vacuum level values; and command the one or more dampers to adjust the amount of the opening in response to the measured airflow or vacuum level being outside the desirable range.

In some examples, the adjustable fastener is manually adjustable.

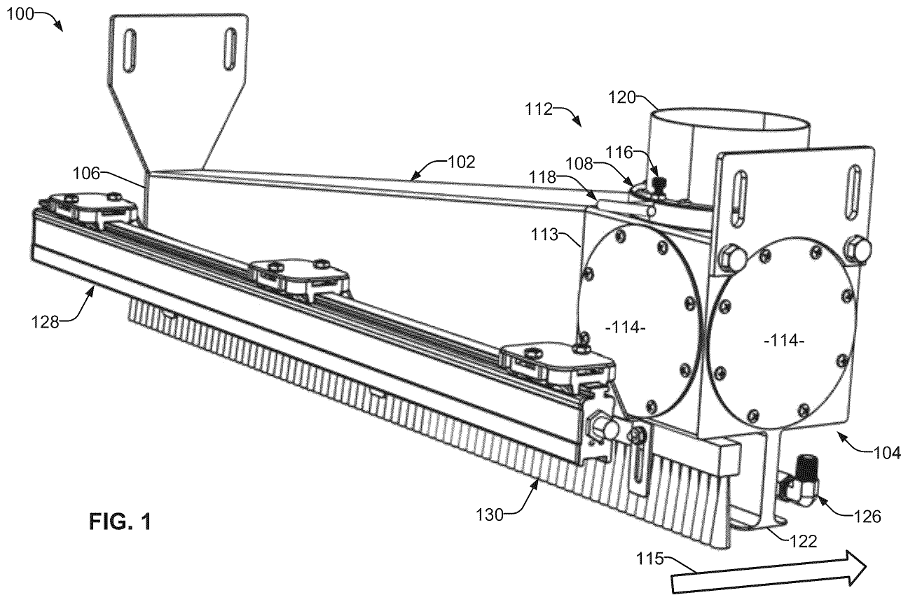

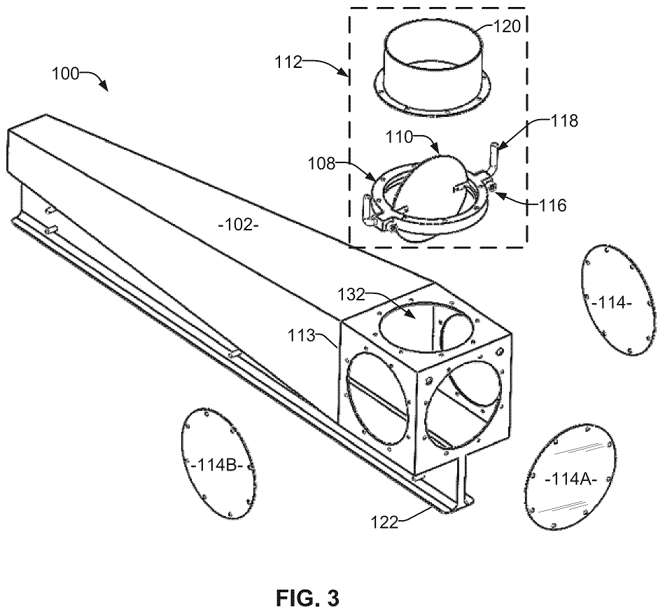

Turning now to the drawings, FIG. 1 illustrates a vacuum system 100 that may incorporate one or more aspects of the presently disclosed components. The system 100 includes an air manifold 102 with a first end 104 and a second end 106. As shown, a damper coupling 112 is arranged through an outlet 132 of a plurality of outlets (see, e.g., FIG. 3) of a frame 113 at the first end 104, the plurality of outlets 132 to exhaust contamination and/or air flow (e.g., drawn to a vacuum collector system via a hose or conduit—not shown).

The outlets are configured to receive a damper coupling 112 that includes a damper collar 108 to support a damper 120, and/or a blank cover 114. Thus, a damper coupling 112 may be mounted to the air manifold 102 via the frame, and provide four (4) outlets, one or more of which can be fitted with a damper or a blank cover. In some examples, the damper coupling 112 is removably mountable to the air manifold 102 at the frame 113.

The disclosed vacuum system 100 can additionally or alternatively include one or more of an air tube 126, a static bar 128, and/or a brush 130. For example, as a material 115 is cleaned by the system 100, it generally moves from right to left. The material is first exposed to ions from the static bar 128, then (optionally) physically contacted by the brush 130 to loosen any contaminants on a surface of the material. Pressurized air from the air tube 126 is directed generally toward the material surface and an inlet flange 122, which provides airflow to aid in removal of the contaminants/contaminated air as the material traverses the system.

Thus, the vacuum system 100 combines a compressed air, static elimination, and/or contact brushes with a vacuum exhaust (at the inlet flange) to agitate the material, thereby removing the static bond between the material and the contaminants. This serves to evacuate surface particulates from the material (e.g., down to approximately 20 microns in size).

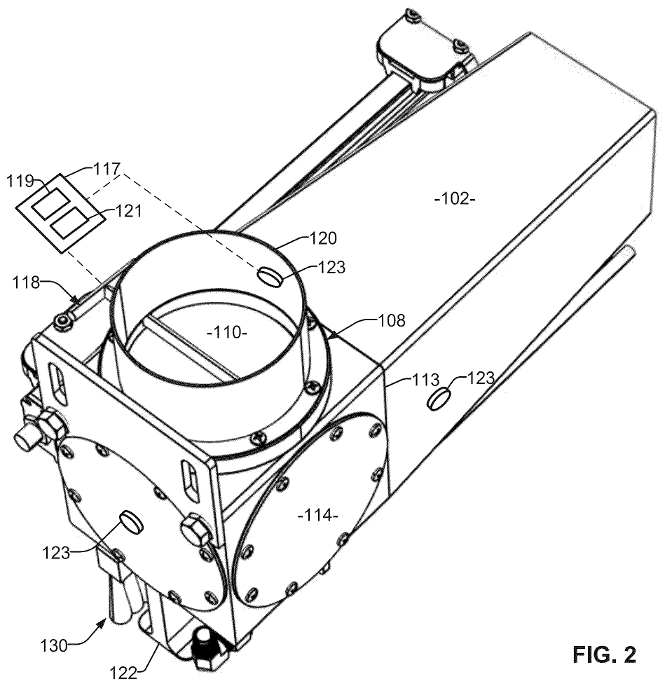

As shown in FIGS. 1 and 2, the damper 112 can include a lever 118 to rotate a plate or blade 110, which changes a position of the plate 110 within the outlet. Once a desired position is achieved, an adjustable fastener 116 can be activated to set the position of the lever 118, and thereby the plate 110. This ensures a consistent opening through which air flows during a cleaning operation.

As disclosed herein, adjusting the position of the plate 110 can be done manually (with or without the use of tools) and/or via automated means. For example, the lever 118 may be a screw, key, knob, handle, or other manually adjustable device, as a list of non-limiting examples. Automatic control of the position of the plate 110 can be provided by a system 117, which may include a processor or control circuitry 119 and an actuator, solenoid, and/or a motor 121, as a list of non-limiting examples. The control circuitry 119 may receive instructions for regulating the airflow (e.g., via a remote computer, user interface, etc.) and/or receive data from one or more sensors 123. For instance, the sensors may provide measurements corresponding to airflow (e.g., a volume of air passing through the damper) and/or a vacuum level (e.g., a pressure differential between the manifold and the environment). One or more sensors 123 may be arranged at one or more locations on or around the vacuum system. For example, the sensors may be arranged on the housing of the system, within and/or about one or more inlets and/or outlets.

Based on the measurements and/or the instructions, the control circuitry 119 can determine a desired amount of airflow, and control the motor 121 to move a position of the lever and/or plate to change the size of the outlet opening. For example, the control circuitry 119 can query a list of plate positions and/or outlet opening sizes corresponding to a desired amount of airflow and/or a particular type of material and/or cleaning operation. Based on the query, and/or a comparison with measured data, the control circuitry 119 can control the motor accordingly. The sensors and/or control circuitry can be employed at a calibration step (e.g., during an initial operating phase), periodically and/or continuously during operation to ensure a desired airflow, and thereby an appropriate amount of cleaning power, is applied to the material during a cleaning operation.

In some examples, the measurements and/or sensor data is transmitted to a user device (e.g., user interface, remote computer, etc.) providing information to an installer. The information can correspond to a desired position and/or amount of change in position needed to reach a desired airflow, thereby providing guidance for manual adjustments.

Although illustrated with a brush 130, in some examples the system 100 can be used without a brush (e.g., a non-contact vacuum system).

FIG. 3 provides an exploded view of the example vacuum system 100, showing the plate 110 rotated so to be transverse with respect to the damper collar 108. The plurality of outlets 132 can be provided with the damper coupling 112, with three blank covers 114 arranged at lateral positions, and the damper coupling 112 arranged opposite the inlet flange 122. In some examples, one or more of the blank covers 114 can be replaced with a damper collar 108, damper 112, and plate 110, whereas the damper collar 108 can be replaced with a blank cover.

In some additional or alternative examples, one or more of the blank covers 114 can be replaced with one or more modified blank covers 114A and/or 114B. For example, blank cover 114A which may be formed of a transparent and/or semi-transparent material to allow an installer to view the interior of the damper coupling 112 and/or the air manifold 102. Example blank cover 114B may be and/or include an adhesive film (e.g., coating, treatment, material), configured to capture contaminants from within the air manifold 102 for later evaluation. The ability to capture and/or analyze contaminants can aid in understanding the origin (e.g., from the environment, the material, etc.) and/or types of contaminants (e.g., dust, debris, particle size, etc.), which can lead to changes to system for optimized operation. This may be of particular benefit for cleaning of optical films and/or specialty coatings.

In some examples, one or more features of a modified blank cover can be combined. Such a blank cover could be formed of a transparent material, which is and/or may be coated with an adhesive film. In some examples, one or more indicators can be applied to a surface of the modified blank cover. The indicators can be of a visual sort, such that as debris collects the indicator (e.g., a logo, text, graphic, etc.) the view of the indicator becomes distorted, the installer is aware of the maintenance needs. The indicator can be substantially flat (e.g., a coating, picture, sticker, etc.), and/or may include one or more 3D features designed to attract and/or collect one or more types of contaminants.

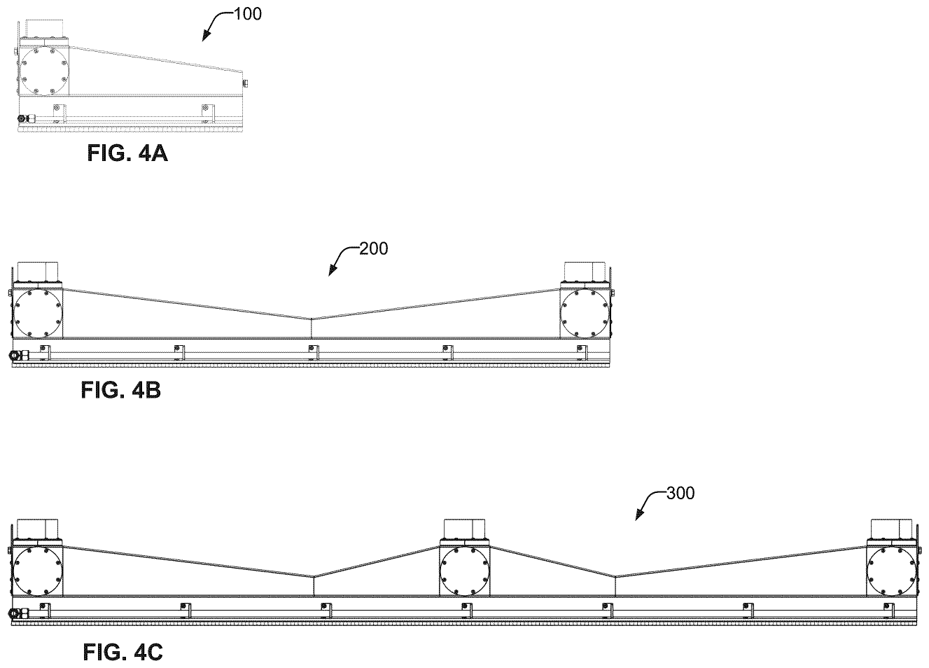

FIGS. 4A to 4C illustrate views of example vacuum system arrangements. In particular, FIG. 4A illustrates a side view of the vacuum system 100 described with respect to FIGS. 1-3. FIG. 4B illustrates a side view of another vacuum system 200, and FIG. 4C illustrates a side view of yet another vacuum system 300. As shown, vacuum system 200 provides two manifolds connected at a second end of each, with damper couplings at opposite ends of the vacuum system 200. Vacuum system 300 generally provides two vacuum systems 200 connected by a damper coupling in the center, with each vacuum system 200 having another damper coupling at opposite ends.

Vacuum systems with multiple air manifolds and/or damper couplings provide flexibly to clean material of various sizes. Further, placement of damper couplings along air manifolds (and thus the connection to a vacuum source) is designed to ensure a reasonably consistent airflow into the inlet flange.

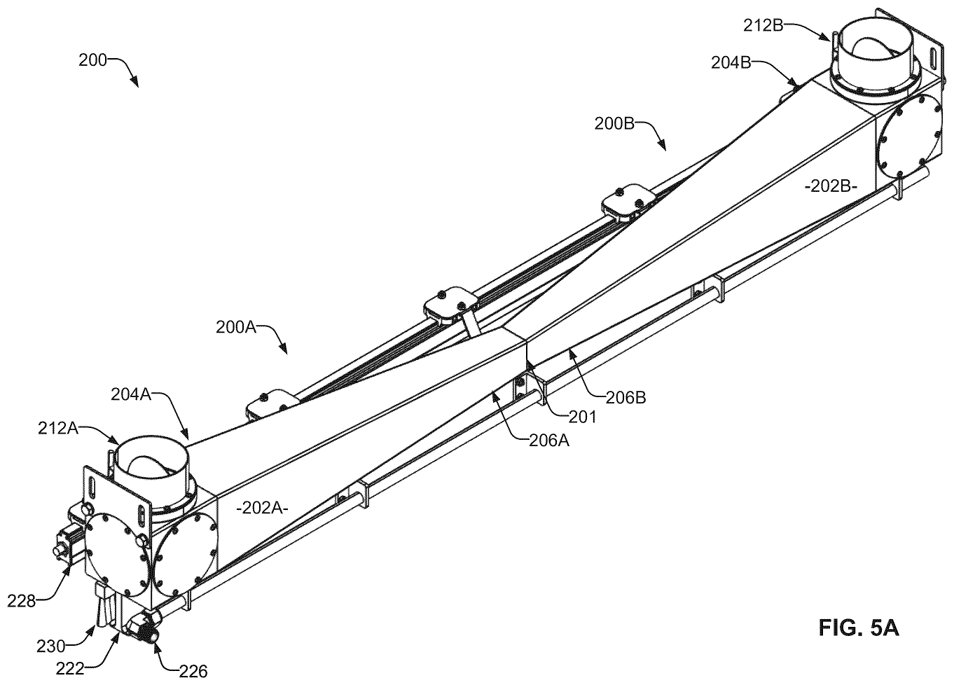

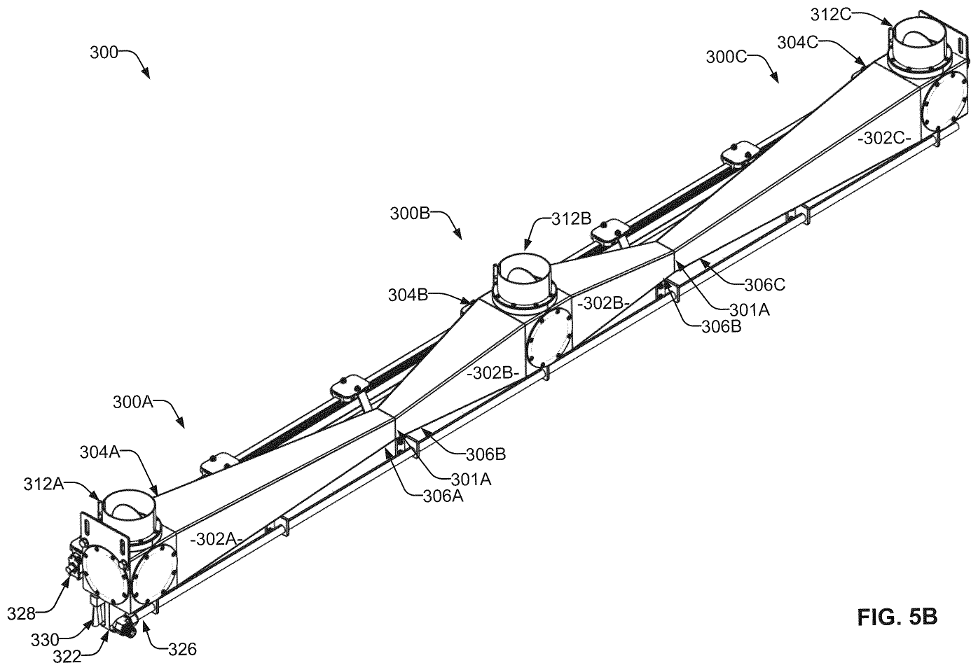

FIG. 5A illustrates a perspective view of the example vacuum system 200 of FIG. 4B. As shown, the vacuum system 200 includes two air manifolds 202A and 202B, each having first ends 204A and 204B, at which damper couplings 212A and 212B are arranged. At second ends 206A and 206B, the two manifolds meet at an interface 201. The second ends 206A and 206B can be open, thereby allow airflow between manifolds at the interface 201, or the second ends 206A and 206B can be sealed. The vacuum system 200 has a single static bar 228, brush 230, and air tube 226 running the length of a single inlet flange 222.

Accordingly, and as shown in the perspective view of vacuum system 300 of 5B, in effect three separate vacuum systems are arranged end-to-end. Two outer vacuum systems 300A and 300C include air manifolds 302A and 302C, each having first ends 304A and 304C, at which damper couplings 312A and 312C are arranged. At second ends 306A and 306C, the two manifolds are joined to a central vacuum system 300B at second ends 306B of two air manifolds 302B, at interfaces 301A.

The first ends 304B of air manifolds 302B connect to a damper coupling 312B, providing another opening for a damper, if so desired. Similar to the vacuum system 200, the vacuum system 300 has a single static bar 328, brush 330, and air tube 326 running the length of a single inlet flange 322. In some examples, the vacuum systems 200 and/or 300 employ two or more static bars, brushes, air tubes, and/or inlet flanges.

Although several examples and/or embodiments are described with respect to a vacuum system for cleaning a material, the principles and/or advantages disclosed herein can employ technologies that are not limited to a particular type of material and/or application.

When introducing elements of various embodiments described below, the articles “a,” “an,” and “the” are intended to mean that there are one or more of the elements. The terms “comprising,” “including,” and “having” are intended to be inclusive and mean that there may be additional elements other than the listed elements. Moreover, while the term “exemplary” may be used herein in connection to certain examples of aspects or embodiments of the presently disclosed subject matter, it will be appreciated that these examples are illustrative in nature and that the term “exemplary” is not used herein to denote any preference or requirement with respect to a disclosed aspect or embodiment. Additionally, it should be understood that references to “one embodiment,” “an embodiment,” “some embodiments,” and the like are not intended to be interpreted as excluding the existence of additional embodiments that also incorporate the disclosed features.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

While only certain features of the invention have been illustrated and described herein, many modifications and changes will occur to those skilled in the art. It is, therefore, to be understood that the appended claims are intended to cover all such modifications and changes as fall within the true spirit of this disclosure.

What is claimed is:

1. A vacuum system for cleaning an object comprising:
an air manifold having a first end and a second end;
one or more damper couplings arranged within one or more outlets to connect to a vacuum collector, the one or more damper couplings being arranged on the first end of the air manifold; and
one or more dampers coupled to the one or more outlets, wherein the one or more dampers are movable relative to the damper coupling to adjust a size of an opening of the one or more dampers.

2. The system of claim 1, wherein the two or more outlets arranged at first and second positions of a frame.

3. The system of claim 2, further comprising a damper collar, wherein each of the two or more outlets are configured to receive a damper of the one or more dampers via the damper collar.

4. The system of claim 2, wherein each of the two or more outlets are configured to receive a blank cover to substantially block evacuation and seal an outlet of the two or more outlets fitted with the blank cover.

5. The system of claim 1, wherein the damper coupling is removably mountable on the first end or the second end of the air manifold.

6. The system of claim 1, wherein the one or more dampers further comprises an adjustable plate configured to change position within the one or more dampers.

7. The system of claim 6, wherein the one or more dampers includes an adjustable lever connected to the adjustable plate, the adjustable lever configured to adjust an opening of the one or more dampers by changing a position or orientation of the adjustable plate.

8. The system of claim 6, wherein the adjustable fastener is manually adjustable.

9. The system of claim 1, wherein the second end of the air manifold is sealed.

10. The system of claim 1, wherein one of the air manifold, the damper coupling, or the damper is formed of a metallic material.

11. The system of claim 1, wherein the air manifold is a first air manifold, the system further comprising a second air manifold with a first end and a second end, the first end of the first air manifold being coupled to the first end of the second air manifold.

12. The system of claim 11, wherein the second air manifold includes a second frame to received one or more damper couplings, the second frame arranged at the second end of the second air manifold opposite the first air manifold.

13. The system of claim 11, further comprising a third air manifold arranged between the first and the second air manifolds, the third air manifold including a third frame to receive one or more damper couplings, the third frame arranged at an end of the third air manifold between the first or the second air manifold.

14. A vacuum system for removing surface contamination from an object comprising:
an air manifold having a first end and a second end;
a frame with one or more outlets to evacuate surface contamination to a vacuum collector, the frame being arranged on the first end of the air manifold;
one or more damper collars coupled to the one or more outlets of the frame, wherein the one or more damper collars are movable relative to the frame to adjust a size of an opening of one or more dampers of the one or more damper collars; and
one or more sensors configured to measure airflow or vacuum level through one or more openings of the one or more dampers.

15. The system of claim 14, wherein the one or more dampers includes an adjustable fastener configured to adjust an opening of the one or more damper collars relative to a surface of the frame.

16. The system of claim 15, further comprising a processor to receive data from the one or more sensors corresponding to the measured airflow or vacuum level.

17. The system of claim 16, further comprising an actuator configured to adjust an amount of the one or more openings of the one or more dampers, wherein the processor is configured to:
determine whether the measured airflow or vacuum level is within a desirable range of airflow or vacuum level values; and
command the one or more dampers to adjust the amount of the opening in response to the measured airflow or vacuum level being outside the desirable range.

18. The system of claim 15, wherein the adjustable fastener is manually adjustable.
